(19) United States
(12) Patent Application Publication
(10) Pub. No.: US 2015/0223158 A1
(43) Pub. Date: Aug. 6, 2015

(54) DISCOVERABLE NETWORK CAPABILITIES OF ACCESS NETWORKS

(71) Applicant: BlackBerry Limited, Waterloo (CA)

(72) Inventors: Stephen McCann, Southampton (GB); Michael Peter Montemurro, Toronto (CA); James Randolph Winter Lepp, Ottawa (CA)

(73) Assignee: BlackBerry Limited, Waterloo (CA)

(21) Appl. No.: 14/173,520

(22) Filed: Feb. 5, 2014

(51) Int. Cl. H04W 48/20

(52) U.S. Cl. CPC H04W 48/20

(57) ABSTRACT

A mobile device is within radio communication range of an access network. The access network is supported by a station (STA), such as an access point, a mesh node, or another mobile device. While the mobile device is not associated with the access network, the mobile device transmits to the STA a request for information about network capabilities of the access network. The STA receives the request and transmits to the mobile device a response conveying information about the network capability of the access network. That response is received by the mobile station. The request and response may be Access Network Query Protocol (ANQP) messages. A new ANQP element organizes information about multimedia capabilities of an access network (that is, how the access network is configured, if at all, to support multimedia). A new ANQP element organizes information about parental control and content filtering capabilities of an access network.

### TECHNICAL FIELD

The technology described herein generally relates to wireless local area networks (WLANs), and more particularly, to the pre-association discovery of capabilities of a WLAN.

### BACKGROUND

Wireless network deployments, such as wireless local area networks (WLANs), allow mobile devices to access network and Internet services when within proximity of wireless communication signals of those wireless networks.

A mobile device that obtains additional network information prior to establishing network connectivity may use the additional network information in its network selection process. The mobile device may be able to avoid unnecessary connection establishment procedures with networks that do not meet the mobile device's needs. The mobile device may be able to ensure that the networks selected for connection establishment procedures meet the mobile device's needs.

Access Network Query Protocol (ANQP) is a query and response exchange protocol that has been defined to allow a mobile device to request network information prior to establishing network connectivity. ANQP uses the General Advertisement Service (GAS) protocol as a transport mechanism.

### SUMMARY

This document proposes making network capabilities of an access network discoverable. For example, a mobile device within radio communication range of an access network may be able to discover information about the multimedia capabilities available in the access network (that is, how the access network is configured, if at all, to support multimedia), or about parental control capabilities in the access network, or about content filtering capabilities of the access network, or any combination thereof.

A mobile device within radio communication range of an access network may transmit to the access network a request for information about network capabilities of the access network. A station (STA) that supports the access network may receive the request. Responsive to receiving the request, the STA may transmit a query request to an Access Network Query Protocol (ANQP) server. Responsive to transmitting the query request, the STA may receive a query response from the ANQP server. Responsive to receiving the query response, the STA may transmit to the mobile device a response to the request for network capability information.

The mobile device may optionally take action based on the response or indication. The mobile device may be in a pre-associated state with respect to the access network while discovering the access network capability information.

A new ANQP element organizes information about multimedia capabilities of an access network (that is, how the access network is configured, if at all, to support multimedia). A new ANQP element organizes information about parental control and content filtering capabilities of an access network.

### BRIEF DESCRIPTION OF THE DRAWINGS

FIG. 1 is a simplified illustration of an example environment in which a mobile device is within radio range of a wireless network;

FIG. 2 is a simplified flowchart illustration of an example network capability discovery method to be performed by a mobile device that is within radio communication range of an access network;

FIG. 3 is a simplified flowchart illustration of an example method for network capability discovery assistance to be performed by a station that supports an access network;

FIGS. 4 to 7 are illustrations of example messaging sequences between a mobile device, a station, and an Access Network Query Protocol (ANQP) server;

FIG. 8 is a block diagram of an example station (STA); and

FIG. 9 is a block diagram of an example mobile device.

### DETAILED DESCRIPTION

The disclosure can be better understood with reference to the following drawings and description. The components in the figures are not necessarily to scale, emphasis instead being placed upon illustrating the principles of the disclosed technology. Moreover, in the figures, like referenced numerals designate corresponding parts or elements throughout the different views. The following description is merely exemplary in nature and is in no way intended to limit the disclosure, its application, or uses.

The seven-layer Open Systems Interconnection (OSI) Reference Model is a concept that describes how data communications should take place. A Physical Layer 1 is the first (lowest) layer. A Data Link Layer 2 has two sub-layers: the upper Logical Link Control (LLC) sub-layer establishes and maintains links between communicating devices; the lower Media Access Control (MAC) sub-layer controls how devices share a media channel. A Network Layer 3 provides switching and routing technologies. Internet Protocol (IP) is the most significant protocol at Layer 3. The other layers are a Transport Layer 4, a Session Layer 5, a Presentation Layer 6, and an Application Layer 7. For the purposes of this document, the term “upper layer protocol (ULP)” refers to a protocol implemented at any of Layer 3 through Layer 7. In the event that the communication architecture is not precisely in accordance with the seven-layer OSI Reference Model, the term “ULP” refers to a protocol implemented at any layer or layers higher than Data Link Layer 2.

ANQP is implemented within the Data Link Layer 2, above the MAC sub-layer. A station management entity (SME) is a layer-independent entity that resides in a separate management plane. Some of the functionality of the SME affects the operation of ANQP and the MAC sub-layer. The SME may effect an interface between layers, for example, an interface between ANQP and any ULPs.

A mobile device that is in a pre-associated state with respect to a wireless network is connected to the wireless network via a layer 2 radio service. However, a mobile device that is in the pre-associated state does not have a connection within the wireless network at any of the layers higher than layer 2 and is unable to communicate within the wireless network using any of the ULPs. That is, a user plane has not yet been established between the mobile device and the wireless network. For example, no session keys have been established and no IP address is assigned to the mobile device.

The IEEE Std. 802.11™-2012 published 29 Mar. 2012 by IEEE Computer Society explains that a mobile device can operate in one of four connection states:

State 1: Initial start state, unauthenticated, un-associated

State 2: Authenticated, not associated

State 3: Authenticated and associated (Pending Robust Security Network Authentication)

State 4: Authenticated and associated.

In the case where the mobile device is compatible (wholly or partially) with the IEEE Std. 802.11™-2012 or future related standards, the pre-associated state refers to the “State 1” connection state (i.e., the “State 1” operation state) or to the “State 2” connection state (i.e., the “State 2” operation state). According to the IEEE Std. 802.11™-2012, no user plane data traffic is permitted while the mobile device is in the “State 1” connection state or in the “State 2” connection state, and any signaling information is insecure and cannot be guaranteed. Further, a mobile device operating in either a “State 1” connection state or a “State 2” connection state may implement the protocols described within this disclosure to determine whether to associate (or not associate) with a given access point (i.e., a given network). In other words, there is no guarantee that a mobile device that implements the protocols described herein will elect to associate with any access point. As such, although, the “State 1” connection state as well as the “State 2” connection states are considered “pre-associated” states of operation, the term “pre-associated” in the present disclosure does not imply that a mobile device operating in a pre-associated state necessarily associates (or attempts association) at some point.

The Wi-Fi® Alliance (WFA) Hotspot 2.0 Specification v5.00 (also referred to as “the Hotspot 2.0 specifications” for Wi-Fi CERTIFIED Passpoint™ products) published January 2014 by the WFA explains that a mobile device can operate in one of four states: Discovery, Registration, Provisioning, and Access. In the case where the mobile device is compatible (wholly or partially) with the Hotspot 2.0 specifications or future related specifications, the pre-associated state refers to the “Discovery” state. According to the Hotspot 2.0 specifications, no user plane data traffic is permitted while the mobile device is in the “Discovery” state, and any signaling information is insecure and cannot be guaranteed.

In this document, the terms “wireless network” and “access network” are used interchangeably, because the wireless networks provide access to external networks. An example of a wireless network is a wireless local area network (WLAN).

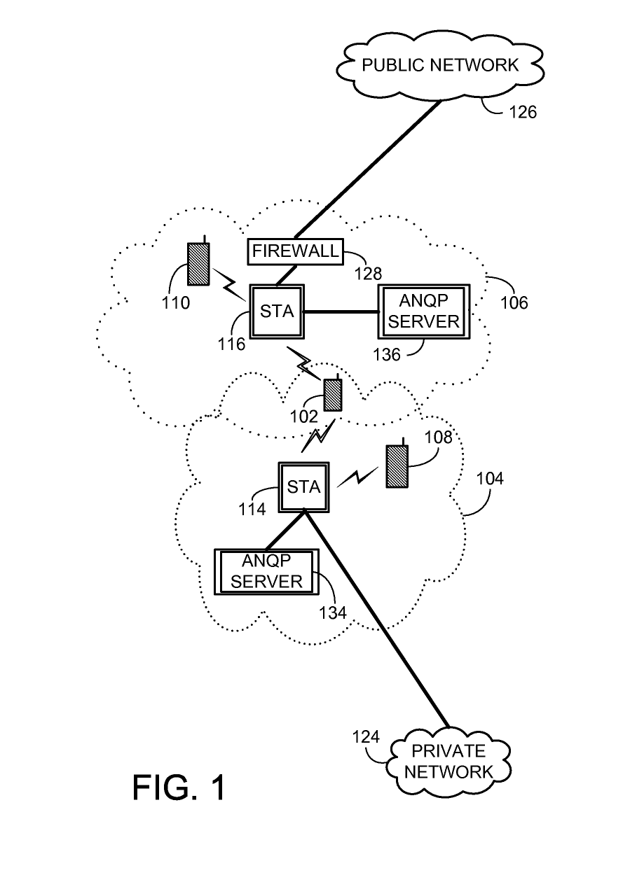

FIG. 1 is a simplified illustration of an example environment in which a mobile device is within radio range of a wireless network. In the example environment illustrated in FIG. 1, a mobile device 102 is within range of a wireless network 104 and within range of a wireless network 106. The mobile device 102 is in the pre-associated state with respect to the wireless network 104 and with respect to the wireless network 106. A mobile device 108 is within range of the wireless network 104 and is in the associated state with respect to the wireless network 104. A mobile device 110 is within range of the wireless network 106 and is in the associated state with respect to the wireless network 106. A station (STA) 114, such as a mobile device, a mesh node or an access point, supports the wireless network 104, and a STA 116 supports the wireless network 106.

The wireless network 104 is an access network, in that it provides access to a private network 124. The wireless network 106 is an access network, in that it provides access to a public network 126, for example, the Internet. A firewall 128 in the wireless network 106 filters all network requests made by mobile devices that are in the associated state with respect to the wireless network 106 (for example, mobile station 110). The level at which the firewall 128 filters content may be configurable, for example, from among a set of predetermined age-based content ratings.

An ANQP server 134 is located within the wireless network 104 and may be co-located with the STA 114 or with its controller (not shown). An ANQP server 136 is located within the wireless network 106 and may be co-located with the STA 116 or with its controller (not shown). The ANQP servers are advertisement servers that contain ANQP elements or information from which ANQP elements can be derived. In particular, the ANQP servers, as proposed in this document, store information about the network capabilities of their respective access networks. For example, the ANQP server 134 may store information about the multimedia capabilities of the wireless network 104. In another example, the ANQP server 136 may store information about the content filtering capabilities of the wireless network 106 and information about the multimedia capabilities of the wireless network 106.

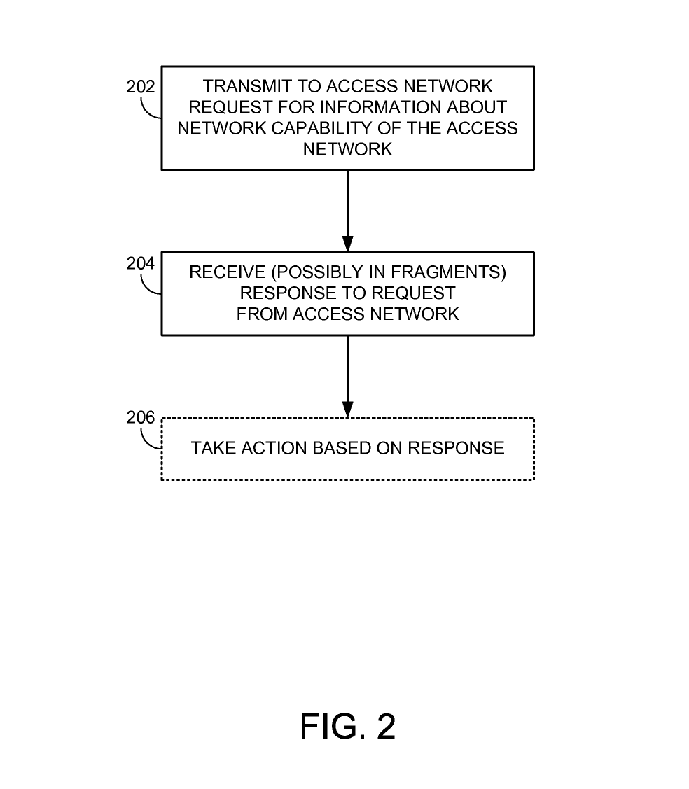

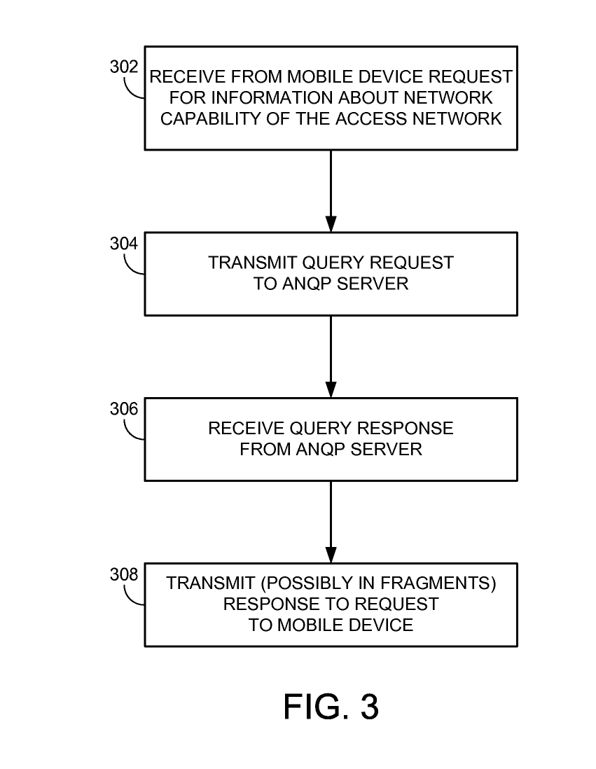

This document proposes making network capabilities of an access network discoverable. For example, a mobile device within radio communication range of an access network may be able to discover information about the multimedia capabilities available in the access network (that is, how the access network is configured, if at all, to support multimedia), or about parental control capabilities in the access network, or about content filtering capabilities of the access network, or any combination thereof. Referring now to FIG. 2 and to FIG. 3, a mobile device within radio communication range of an access network may transmit (at 202) to the access network a request for information about network capabilities of the access network. A STA that supports the access network may receive (at 302) the request. Responsive to receiving the request, the STA may transmit (at 304) a query request to an ANQP server. Responsive to transmitting the query request, the STA may receive (at 306) a query response from the ANQP server. Responsive to receiving the query response, the STA may transmit (at 308) to the mobile device a response to the request for network capability information. From the mobile device's perspective, responsive to transmitting the request for network capability information, the mobile device may receive (at 204) from the access network a response to the request (or an indication, such as an error code, that the requested information is not available). Optionally, the mobile device may take action (at 206) based on the response or indication. The mobile device may be in a pre-associated state with respect to the access network while discovering the access network capability information. As for what action is taken, the mobile device, responsive to discovering the access network capability information, may use this information to choose whether to attempt to connect to a particular wireless network or not, to choose between multiple wireless networks, or to change the behavior of upper layer applications, or to inform a user of the mobile device. The General Advertisement Service (GAS) protocol is used as a transport mechanism for the request sent by the mobile device and the response sent by the STA. The example methods illustrated in FIG. 2 and FIG. 3 are illustrative of the case where the STA pauses for the ANQP server and the query response is small enough to fit into a single GAS initial response. However, for those cases where the query response is larger, GAS fragmentation is used for delivery, as known in the art.

Not all access networks are able to provide the same support for multimedia traffic. Some access networks are configured to block particular types of multimedia traffic, for example, an access network configured to block streaming multimedia. The capability of a network may vary based on the level of a user subscription—basic, premium, or the amount of load on the backhaul. In addition, certain backhaul providers may block streaming multimedia (e.g. Netflix®) if too many subscribers try to access it simultaneously.

A mobile device may initiate the query of access network multimedia capability as part of periodic procedures to scan for new or better access networks, in response to a user action, or in response to an application running on the mobile device.

For example, a communication application may be capable of voice calls, standard definition video calls, and high definition video calls. Based on the user or application settings or actions, the mobile device may choose not to connect to a particular access network because that particular access network does not have certain multimedia capabilities.

In another example, the mobile device may choose to connect to an access network from which it has received information indicating lower multimedia capabilities, but then change the operation of the mobile device while connected by restricting some options to the user (such as allowing standard definition video but blocking high definition video).

In a further example, a mobile device that supports Unlicensed Mobile Access (UMA) or IP Multimedia Subsystem (IMS) applications may seek information that an access network is capable of supporting voice and video to influence its decision to handover voice or video services to the access network.

In yet another example, a video conferencing application at a mobile device may use information that an access network is capable of supporting high bandwidth video and low bandwidth voice to change its behavior. For example, the video conferencing application may select an audio codec that is more suitable for low bandwidth voice.

Content ratings exist in many jurisdictions and several domains. Historically used for rating films, music and television, these have more recently been applied to other content and forms of entertainment such as software and video games. Computer, mobile phone, tablet, video game consoles and other device operating systems have evolved to integrate content ratings, which may be based on age. All content available to users of the device may be filtered such that material of a higher age rating is not available. Existing implementations of parental controls on mobile phones or video games have no way of enforcing their policy on web browsers or other general Internet applications. Such implementations resort to giving the web browsers and other general Internet applications a high age rating (thus blocking access to the web browser itself thereby filtering all content), which is not ideal.

Some access networks implement a content filtering mechanism. All network requests sent by a mobile device that is associated with the access network are filtered at a firewall or similar node in the network. The content filtering mechanism may offer a single level of filtering, or may be configurable to any one of multiple levels of filtering. An access point may offer multiple levels of filtering by presenting more than one network name (also known as a service set identifier (SSID)), where each network name has a different level content filter associated therewith. In this case, the access point appears to support several different networks (base service sets (BSSs)). Mobile devices may select for connection the BSS that has a desired content filtering capability. In order to determine the content filtering capability of each BSS, the mobile device may query the access network content filtering capability as described in this document.

A mobile device may initiate the query of access network content filtering capability as part of periodic procedures to scan for new or better access networks, in response to a user action, or in response to an application running on the mobile device.

For example, a mobile device may choose not to connect to an access network that does not have content filtering capability.

In another example, a mobile device may allow connections to an access network that does not have content filtering capability, but may have its operating system change what the user (or applications) can and cannot access. For example, certain “walled garden” online services may be available, but general connections may not be permitted, or may be routed through a filtering proxy.

In a further example, a mobile device may allow connections to an access network that has content filtering capability and offers filtering at more permissive levels than desired, and then may have its operating system change what the user (or applications) can and cannot access. For example, if the access network filters out content that is rated as not suitable for persons under the age of 15, and the mobile device desires filtering out content that is rate as not suitable for persons under the age of 9, the mobile device may have its operating system implement additional filtering.

In general, based on the desired filtering level (set at the mobile device) and the content filtering capability of the access network as discovered by the mobile device in a pre-associated state, the mobile device may: i) choose to associate and operate as normal (that is, without additional restriction to the user, relying on network filtering); ii) choose not to associate; iii) choose to associate but apply additional restrictions (for example, application-specific restrictions).

Access Network Query Protocol (ANQP)

This document proposes using ANQP to make network capabilities of an access network discoverable. A mobile device within radio communication range of an access network uses ANQP to discover information about the network capabilities of the access network as follows. The access network is supported by a station (STA), such as an access point, a meshnode, or another mobile device. An ANQP server is an advertisement server that is located in (or accessible by) the access network. The ANQP server may be co-located with the STA that supports the access network. The ANQP server may be co-located with a controller of the STA that supports the access network. ANQP queries and ANQP responses use ANQP elements that organize information in a predetermined manner. The ANQP server stores ANQP elements or information from which ANQP elements can be derived.

This document proposes defining a new ANQP element to organize information about multimedia capabilities of an access network, and a new ANQP element to organize information about parental control and content filtering capabilities of an access network.

Defining these new ANQP elements involves modifying the existing IEEE 802.11 ANQP information ID definitions to include an information ID for Multimedia Capability and an information ID for Content Filtering Capability, for example, as follows:

TABLE 1
ANQP Element Information ID definitions (IEEE 802.11)

| ANQP-element name | InfoID |
|---|---|
| Reserved | 0-255 |
| Query List | 256 |
| Capability List | 257 |
| Venue Name | 258 |
| Emergency Call Number | 259 |
| Network Authentication Type | 260 |
| Roaming Consortium | 261 |
| IP Address Type Availability | 262 |
| NAI Realm | 263 |
| 3GPP Cellular Network | 264 |
| AP Geospatial Location | 265 |
| AP Civic Location | 266 |
| AP Location Public Identifier URI | 267 |
| Domain Name | 268 |
| Emergency Alert Identifier URI | 269 |
| TDLS Capability | 270 |
| Emergency NAI | 271 |
| Neighbor Report | 272 |
| Multimedia Capability | 273 |
| Content Filtering Capability | 274 |
| Reserved | 275-56796 |
| Vendor Specific | 56797 |
| Reserved | 56798-65535 |

Defining these new ANQP elements involves modifying the existing Hotspot 2.0 ANQP Element Subtype definitions to include a Subtype Value for Multimedia Capability and a Subtype Value for Content Filtering Capability, for example, as follows:

TABLE 2
ANQP Element Subtype Value definitions (Hotspot 2.0)

| ANQP-element name | Subtype Value |
|---|---|
| Reserved | 0 |
| HS Query list | 1 |
| HS Capability list | 2 |
| Operator Friendly Name | 3 |
| WAN Metrics | 4 |
| Connection Capability | 5 |
| NAI Home Realm Query | 6 |
| Operating Class Indication | 7 |
| OSU Providers list | 8 |
| Reserved | 9 |
| Icon Request | 10 |
| Icon Binary File | 11 |
| Multimedia Capability | 12 |
| Content Filtering Capability | 13 |
| Reserved | 14-255 |

The Query List ANQP element (InfoID 1, Subtype Value 1) is defined to provide indications (Information IDs or Subtype Values) of the ANQP elements for which the mobile device is requesting information. The Capability List ANQP element (InfoID 2, Subtype Value 2) is defined to provide indications (InfoIDs or Subtype Values) of the ANQP elements for which the ANQP server has information.

Multimedia Capability

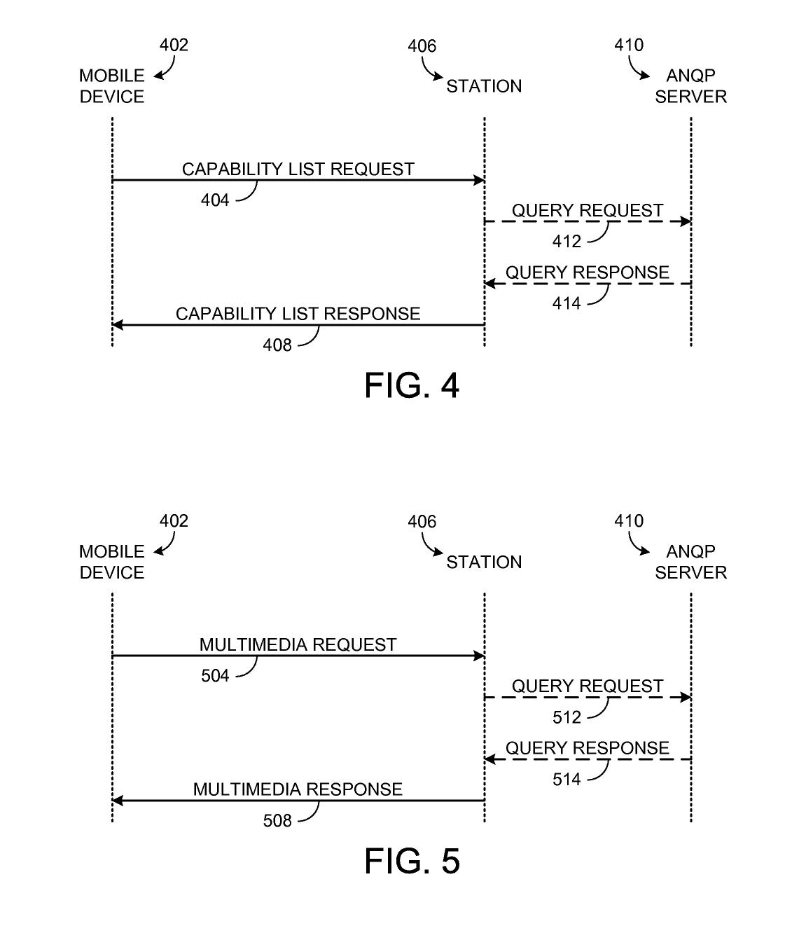

Referring now to FIG. 4, a mobile device 402 may generate and transmit an ANQP query request 404 to a STA 406, the ANQP query request 404 conveying a Query List ANQP element that provides an indication of the Capability List ANQP element (“capability list request”). Responsive to the capability list request 404, the STA 406 may generate and transmit an ANQP query response 408 to the mobile device, the ANQP query response conveying a Capability List ANQP element received from an ANQP server 410 (or derived from information received from the ANQP server 410) (“capability list response”). If the Capability List ANQP element does not provide an indication (InfoID or Subtype Value) of the Multimedia Capability ANQP element, this means that the ANQP server 410 does not have information about the multimedia capabilities of the access network and consequently the mobile device 402 is unable to obtain that information using ANQP. Communications between the STA 406 and the ANQP server 410 are illustrated in FIG. 4 as a query request 412—query response 414 exchange, the details of which are beyond the scope of this document.

Referring now to FIG. 5, the mobile device 402 may generate and transmit an ANQP query request 504 to the STA 406, the ANQP query request 504 conveying a Query List ANQP element that provides an indication (InfoID or Subtype Value) of the Multimedia Capability ANQP element (“multimedia request”). The Query List ANQP element may also provide indications (InfoID or Subtype Value) of one or more other ANQP elements. If an ANQP query response from the STA 406 does not convey a Multimedia Capability ANQP element or an error code is returned, this means that the ANQP server 410 does not have information about the multimedia capabilities of the access network and consequently the mobile device 402 is unable to obtain that information using ANQP.

If the ANQP server 410 does have information about the multimedia capabilities of the access network, the STA 406 will respond to the multimedia request 504 with an ANQP query response 508 conveying a Multimedia Capability ANQP element (“multimedia response”). Communications between the STA 406 and the ANQP server 410 are illustrated in FIG. 5 as a query request 512—query response 514 exchange, the details of which are beyond the scope of this document.

The multimedia request 504 may be generated and transmitted by the mobile device 402 responsive to a capability list request 404—capability list response 408 exchange where the Capability List ANQP element in the capability list response 404 does provide an indication (InfoID or Subtype Value) of the Multimedia Capability ANQP element. Alternatively, the multimedia request 504 may be generated and transmitted by the mobile device 402 without first conducting a capability list request 404—capability list response 408 exchange.

As with all ANQP exchanges, the capability list request 404—capability list response 408 exchange and the multimedia request 504—multimedia response 508 exchange both use the General Advertisement Service (GAS) protocol as a transport mechanism. The example messaging sequences illustrated in FIG. 4 and FIG. 5 are illustrative of the case where the STA 406 pauses for the ANQP server 410 and the query response is small enough to fit into a single GAS initial response. However, for those cases where the query response is larger, GAS fragmentation is used for delivery, as known in the art.

The information about the multimedia capabilities of the access network may be obtained by the ANQP server in any number of ways. For example, the information may be static information that is manually configured at the ANQP server by an administrator. In another example, the ANQP server may discover dynamic information about the access network from measurements or reports. In a further example, the ANQP server may be connected to a centralized controller that provisions the ANQP server with the dynamic information about the access network.

The information about the multimedia capabilities of the access network may be conveyed as broad categories, or as specific multimedia types, or as actual bandwidth/delay/jitter values, or in any other suitable way.

A Multimedia Capability Bitmask may be used to convey the information. In one example, the values of the Multimedia Capability Bitmask may be set according to the following table:

TABLE 3
Multimedia Capability Bitmask Settings Example 1

| Description | Bit |
|---|---|
| Streaming | 0 |
| Streaming Multimedia | 1 |
| Interactive | 2 |
| Best Effort | 3 |
| Video | 4 |
| Voice | 5 |
| Reserved | 6-7 |

In this example, a bit mask of 01100100 indicates support for Streaming Multimedia, Interactive, and Voice.

In an alternative example, the Multimedia Capability Bitmask may be set according to the following table:

TABLE 4
Multimedia Capability Bitmask Settings Example 2

| Description | Bit |
|---|---|
| Voice Capability | 0 |
| Video Capability | 1 |
| High Bandwidth Voice Capability | 2 |
| Low Bandwidth Voice Capability | 3 |
| High Bandwidth Video Capability | 4 |
| Low Bandwidth Video Capability | 5 |
| Reserved | 6-7 |

In this example, a bit mask of 11100100 indicates support for Voice Capability, Video Capability, High Bandwidth Voice Capability, and Low Bandwidth Video Capability.

By including reserved bits in the example tables above, extensions may be added in a backwards-compatible manner. Mobile devices built to support the example tables above will ignore the values of the reserved bits. If those bits are defined in the future, their value will not impact legacy mobile devices.

The examples above are for a 1-octet Multimedia Capability Bitmask. If required, a larger bitmask could be used.

Although two different examples are provided above, a single standardized definition of the Multimedia Capability Bitmask will ultimately be implemented, so that mobile devices, STAs and ANQP servers interpret the Multimedia Capability Bitmask uniformly. That is, although the meaning and significance of High Bandwidth Voice Capability may vary from one implementation to another, all compatible mobile devices, STAs and ANQP servers will use bit 2 of the Multimedia Capability Bitmask to indicate the existence or lack of High Bandwidth Voice Capability in the access network, in the case where the Multimedia Capability Bitmask field is set according to the example in TABLE 4.

A Multimedia Capability ANQP element may be defined for Hotspot 2.0 as organizing information in the following example format:

TABLE 5
Multimedia Capability element (Hotspot 2.0)

| | Multimedia Capability Bitmask |
|---|---|
| Octets: | 1 |

A Multimedia Capability ANQP element may be defined for IEEE 802.11 as organizing information in the following example format:

TABLE 6
Multimedia Capability ANQP-element (IEEE 802.11)

| | Info ID | Length | Multimedia Capability Bitmask |
|---|---|---|---|
| Octets: | 2 | 2 | 1 |

In the IEEE 801.11 definition, the 2-octet Info ID field identifies the ANQP element as being a Multimedia Capability ANQP-element by setting the Info ID field to, for example, the value ‘273’, and the 2-octet Length field in this example is set to the value ‘1’ to indicate the length of the 1-octet Multimedia Capability Bitmask field.

In both definitions, the Multimedia Capability Bitmask field contains a Multimedia Capability Bitmask that indicates multimedia capabilities of the access network. Alternative examples of how to set the Multimedia Capability Bitmask are provided above in TABLE 3 and TABLE 4.

Parental Control and Content Filtering Capability

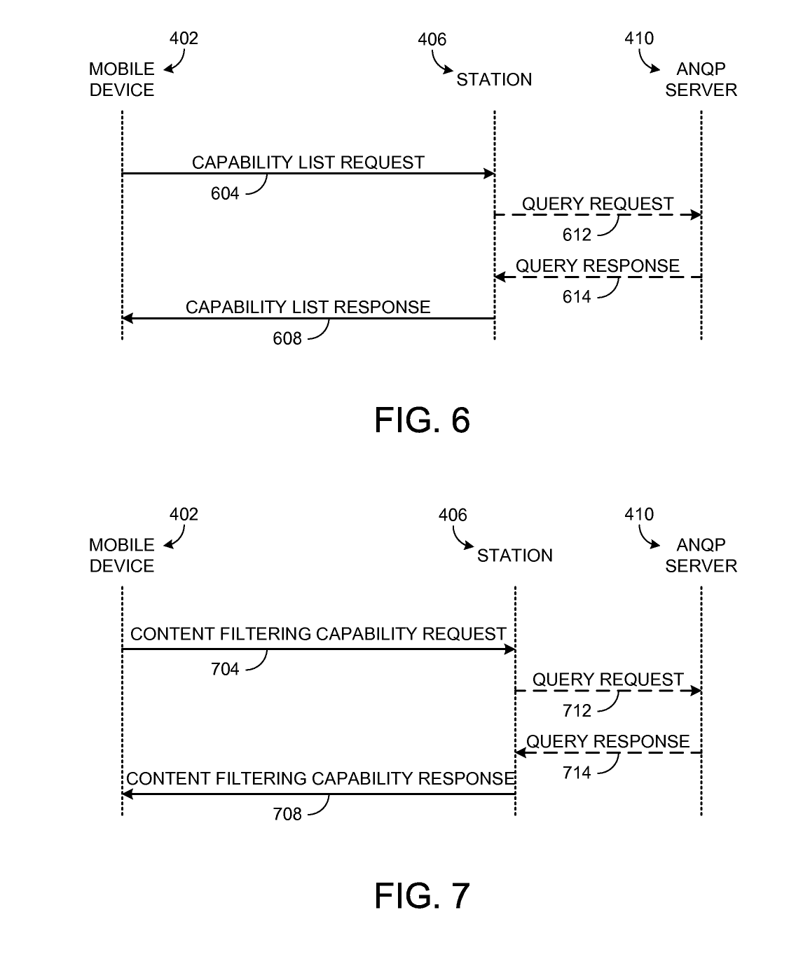

Referring now to FIG. 6, the mobile device 402 may generate and transmit an ANQP query request 604 to the STA 406, the ANQP query request 604 conveying a Query List ANQP element that provides an indication of the Capability List ANQP element (“capability list request”). The Query List ANQP element may also provide indications (InfoID or Subtype Value) of one or more other ANQP elements. Responsive to the capability list request 604, the STA 406 may generate and transmit an ANQP query response 608 to the mobile device, the ANQP query response 608 conveying a Capability List ANQP element received from the ANQP server 410 (or derived from information received from the ANQP server 410) (“capability list response”). If the Capability List ANQP element does not provide an indication (InfoID or Subtype Value) of the Content Filtering Capability ANQP element, this means that the ANQP server 410 does not have information about the parental control and content filtering capabilities of the access network and consequently the mobile device 402 is unable to obtain that information using ANQP. A mobile device 402 that receives an ANQP query response conveying a Capability List ANQP element that does not provide an indication (either InfoID or Subtype Value) of the Content Filtering Capability ANQP element may determine that the access network does not have any parental control or content filtering capabilities. Communications between the STA 406 and the ANQP server 410 are illustrated in FIG. 6 as a query request 612—query response 614 exchange, the details of which are beyond the scope of this document.

Referring now to FIG. 7, the mobile device 420 may generate and transmit an ANQP query request 704 to the STA 406, the ANQP query request 704 conveying a Query List ANQP element that provides an indication (InfoID or Subtype Value) of the Content Filtering Capability ANQP element (“content filtering capability request”). If the ANQP query response from the STA 406 does not convey a Content Filtering Capability ANQP element or an error code is returned, this means that the ANQP server 410 does not have information about the parental control and content filtering capabilities of the access network and consequently the mobile device 402 is unable to obtain that information using ANQP. In this case, the mobile device 402 may determine that the access network does not have any parental control or content filtering capabilities.

If the ANQP server 410 does have information about the parental control and content filtering capabilities of the access network, the STA 406 will respond to the content filtering capability request 704 with an ANQP query response 708 conveying a Content Filtering Capability ANQP element (“content filtering capability response”). Communications between the STA 406 and the ANQP server 410 are illustrated in FIG. 7 as a query request 712—query response 714 exchange, the details of which are beyond the scope of this document.

The content filtering capability request 704 may be generated and transmitted by the mobile device 402 responsive to a capability list request 604—capability list response 608 exchange where the Capability List ANQP element in the capability list response 608 does provide an indication (InfoID or Subtype Value) of the Content Filtering Capability ANQP element. Alternatively, the content filtering capability request 704 may be generated and transmitted by the mobile device 402 without first conducting a capability list request 604—capability list response 608 exchange.

As with all ANQP exchanges, the capability list request 604—capability list response 608 exchange and the content filtering capability request 704—content filtering capability response 708 exchange both use the GAS protocol as a transport mechanism. The example messaging sequences illustrated in FIG. 6 and FIG. 7 are illustrative of the case where the STA 406 pauses for the ANQP server 410 and the query response is small enough to fit into a single GAS initial response. However, for those cases where the query response is larger, GAS fragmentation is used for delivery, as known in the art.

The information about the parental control and content filtering capabilities of the access network may be obtained by the ANQP server in any number of ways. For example, the information may be static information that is manually configured at the ANQP server by an administrator.

A Content Filtering Capability ANQP element may be defined for Hotspot 2.0 as organizing information in the following example format:

TABLE 7
Content Filtering Capability element (Hotspot 2.0)

| | Content Filtering Capability Bitmask |
|---|---|
| Octets: | 1 |

A Content Filtering Capability ANQP element may be defined for IEEE 802.11 as organizing information in the following format:

TABLE 8
Content Filtering Capability ANQP-element (IEEE 802.11)

| | Info ID | Length | Content Filtering Capability Bitmask |
|---|---|---|---|
| Octets: | 2 | 2 | 1 |

In the IEEE 801.11 definition, the 2-octet Info ID field identifies the ANQP element as being a Content Filtering Capability ANQP-element by setting the Info ID field to, for example, the value ‘274’, and the 2-octet Length field in this example is set to the value ‘1’ to indicate the length of the 1-octet Content Filtering Capability Bitmask field.

In both definitions, the Content Filtering Capability Bitmask field indicates content filtering capabilities of the access network. For example, the Content Filtering Capability Bitmask field may be set according to the following table:

TABLE 9
Content Filtering Capability Bitmask Settings Example

| Description | Bit |
|---|---|
| Unrated | 0 |
| 4+ | 1 |
| 9+ | 2 |
| 12+ | 3 |
| 15+ | 4 |
| 18+ | 5 |
| Restricted 18+ | 6 |
| Reserved | 7 |

The example 7-level rating system described in the above table is able to map almost all of the content rating systems. With the large number of rating systems in use worldwide, if an exact mapping isn't possible, a conversion can be made to the closest rating.

For example, the Classification and Rating Administration (CARA) ratings used for films in the United States may be mapped to the example 7-level rating system as follows:

TABLE 10
Example mapping of CARA ratings to example 7-level rating system

| CARA rating | | 7-level rating |
|---|---|---|
| G | → | 4+ |
| PG | → | 9+ |
| PG-13 | → | 12+ |
| R | → | 18+ |
| NC-17 | → | Restricted 18+ |

In another example, the ratings used for films by the Ontario Film Board in Canada may be mapped to the example 7-level rating system as follows:

TABLE 11
Example mapping of OFB ratings to example 7-level rating system

| OFB rating | | 7-level rating |
|---|---|---|
| General | → | 4+ |
| Parental Guidance | → | 9+ |
| 14A | → | 15+ |
| 18A | → | 18+ |
| Restricted | → | Restricted 18+ |

In a further example, the ratings used by the British Board of Film Classification (BBFC) in the United Kingdom may be mapped to the example 7-level rating system as follows:

TABLE 12
Example mapping of BBFC ratings to example 7-level rating system

| BBFC rating | | 7-level rating |
|---|---|---|
| U | → | 4+ |
| PG | → | 9+ |
| 12A (cinema) | → | 12+ |
| 12 (video) | → | 12+ |
| 15 | → | 15+ |
| 18 | → | 18+ |
| R18 | → | Restricted 18+ |

In yet another example, the ratings used by Apple's App Store^{SM} to classify apps may be mapped to the example 7-level rating system as follows:

TABLE 13
Example mapping of Apple App Store ^{SM} classifications to example
7-level rating system

| Apple App Store ^{SM} | | |
|---|---|---|
| classification | | 7-level rating |
| 4+ | → | 4+ |
| 9+ | → | 9+ |
| 12+ | → | 12+ |
| 17+ | → | 18+ |

In an additional example, the ratings used by the TV Parental Guidelines Monitoring Board to classify television programs in the United States may be mapped to the example 7-level rating system as follows:

TABLE 14
Example mapping of TV Parental Guidelines ratings to example 7-level
rating system

| TV Parental | | |
|---|---|---|
| Guidelines rating | | 7-level rating |
| TV-Y | | 4+ |
| TV-Y7 | → | 9+ |
| TV-G | → | 9+ |
| TV-PG | → | 12+ |
| TV-14 | → | 15+ |
| TV-MA | → | 18+ |

Some rating systems are not based on age, but rather include lists of specific content flags. For example, the V-Chip technology used in Canada, the United States and Brazil employs the following content flags for television programs that are used in addition to an age-based rating: FV (fantasy or animated violence), V (violence), S (sexual situations), L (language) and D (suggestive dialog). Age-based ratings together with content flags may be mapped to the example 7-level rating system as follows:

TABLE 15
Example mapping of TV Parental Guidelines ratings with V-Chip content
flag to example 7-level rating system

| TV Parental | | V-Chip | | |
|---|---|---|---|---|
| Guidelines rating | | content flag | | 7-level rating |
| TV-Y | and | FV or D | → | 9+ |
| TV-Y7 | and | V or S | → | 12+ |
| TV-G | and | V or L or D | → | 12+ |
| TV-PG | and | V or S | → | 15+ |
| TV-14 | and | V or S | → | 18+ |
| TV-MA | and | V or S | → | Restricted 18+ |

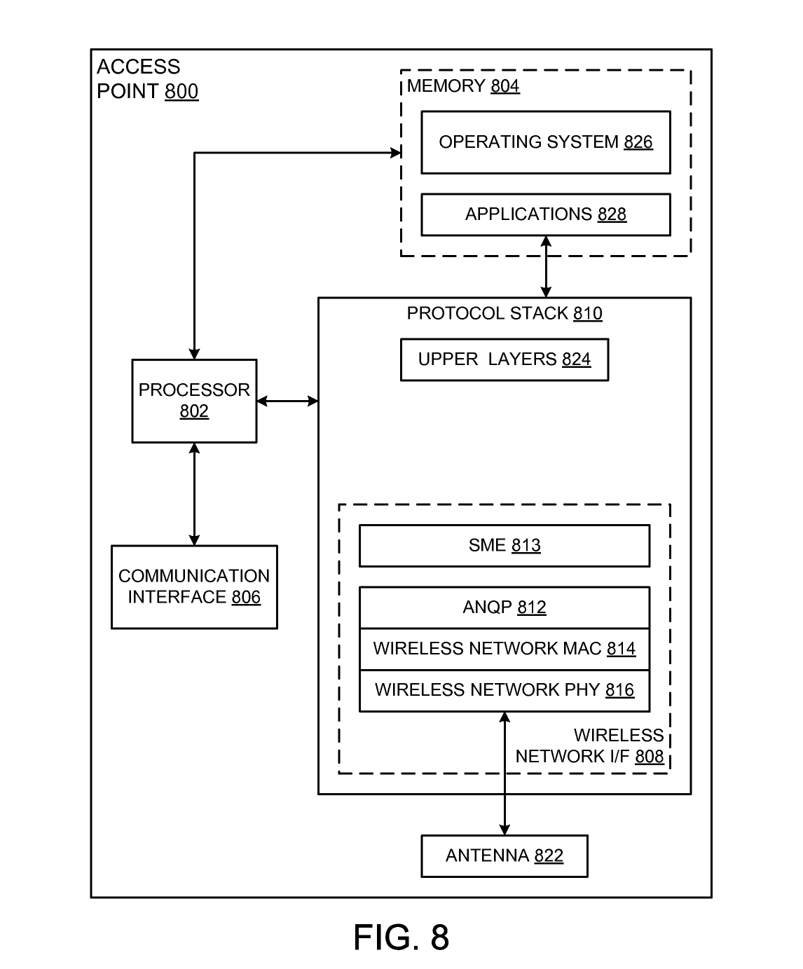

FIG. 8 is a block diagram of an example station (STA) 800. The STA 800 comprises a processor 802 coupled to a memory 804 and to a communication interface 806. Communication interface 806 may be a wired communication interface, a satellite interface, a Worldwide Interoperability for Microwave Access (WiMAX®) communication interface, or any other suitable communication interface. The STA 800 also comprises a wireless network interface 808 within a protocol stack 810 that is coupled to the processor 802. The wireless network interface 808 comprises a physical layer 1 module 816, a MAC module 814 at a lower sub-layer of layer 2, and an ANQP module 812 above the MAC module 814. The STA 800 also comprises an antenna 822 coupled to the physical layer 1 module 816. The protocol stack 810 may comprise upper layers 824. The ANQP module 812 may implement the newly defined ANQP elements described above. The STA 800 also comprises a Station Management Entity (SME) module 813 having various management functions.

The memory 804 may store an operating system 826 to be executed by the processor 802. The memory 804 may store applications 828 installed in the STA 800 to be executed by the processor 802. Examples of the applications 828 include a configuration application that enables a network administrator to configure parameters of the wireless network, for example, its network name.

The STA 800 may comprise other elements that, for clarity, are not illustrated in FIG. 8. Likewise, the STA 800 may comprise a subset of the elements illustrated in FIG. 8.

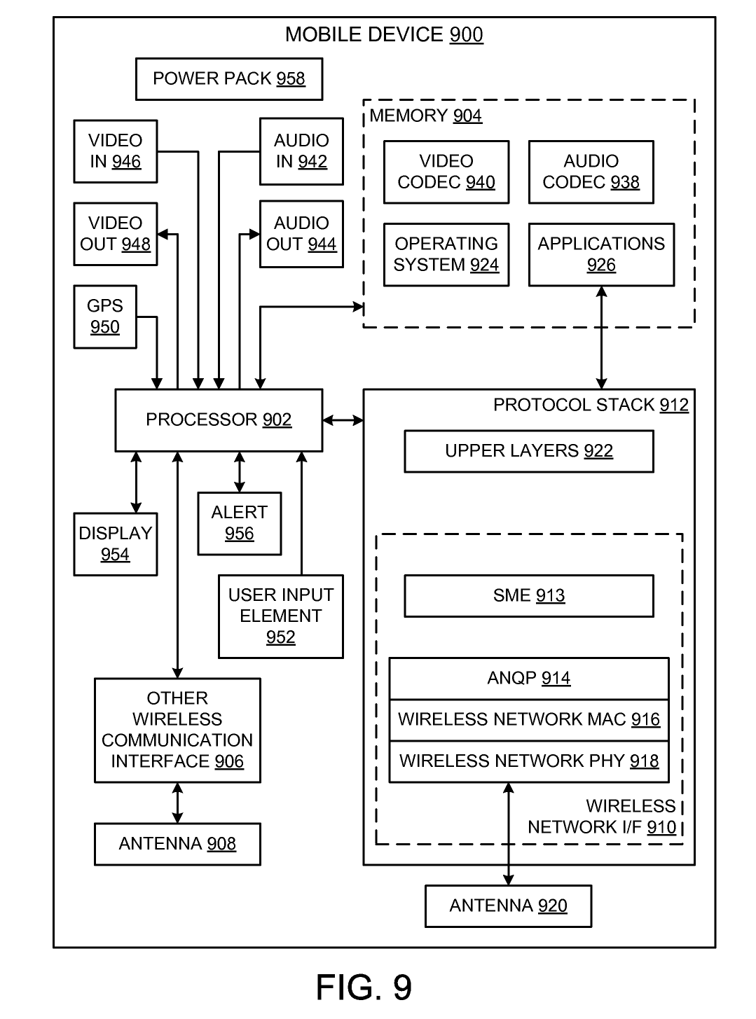

FIG. 9 is a block diagram of an example mobile device 900. A mobile device 900 comprises a processor 902 coupled to a memory 904 and optionally to one or more other wireless communication interfaces 906. For example, wireless communication interfaces 906 may comprise a short-range wireless communication interface such as a wireless personal area network interface. In another example, wireless communication interfaces 906 may comprise a wireless wide area network (WWAN) interface such as for cellular communications. One or more antennas 908 may be coupled to respective ones of the wireless communication interfaces 906. An antenna may be shared among more than one wireless interface.

The mobile device 900 also comprises a wireless network interface 910 within a protocol stack 912 that is coupled to processor 902. The wireless network interface 910 comprises a physical layer 1 module 918, a MAC module 916 at a lower sub-layer of layer 2, and an ANQP module 914 above the MAC module 916. The mobile device 900 also comprises an antenna 920 coupled to the physical layer 1 module 918. The protocol stack 912 may comprise upper layers 922. The ANQP module 914 may implement the newly defined ANQP elements described above. The mobile device 900 also comprises a Station Management Entity (SME) module 913 that, among its various management functions, manages network selection by the wireless network interface 910. The SME module 913 may use the information about the multimedia capabilities of the wireless network, or the information about the parental control and content filtering capabilities of the wireless network, or both, when performing network selection.

The memory 904 may store an operating system 924 to be executed by the processor 902. The memory 904 may store applications 926 installed in the mobile device 900 be executed by the processor 902. The memory 904 may also store data (not shown) used by operating system 924 and applications 926.

The memory 904 may store an audio coder-decoder (codec) 938 or a video codec 940 or both. The mobile device 900 may comprise an audio input element 942 and an audio output element 944, both coupled to the processor 902. The mobile device 900 may comprise a video input element 946 and a video output element 948, both coupled to the processor 902.

The mobile device 900 may comprise a Global Positioning System (GPS) module 950 coupled to the processor 902.

The mobile device 900 may comprise one or more user input elements 952 coupled to the processor 902. Examples of user input elements include a keyboard, a keypad, a touchscreen, a joystick, a thumbwheel, a roller, a touchpad, a trackpad, a capacitive touch pad, an optical touch pad, and any other type of navigation actuator.

The mobile device 900 may comprise one or more user output elements coupled to the processor 902, of which a display 954 is illustrated. In the event that the display 954 is a touchscreen, it functions also as a user input element.

The mobile device 900 may comprise one or more alert components 956 coupled to the processor 902, to be activated in order to alert a user, for example, by sounding a buzzer, playing a ringtone, emanating light, or vibrating.

The mobile device 900 may include mechanical interfaces, such as a power connector jack, a data interface port such as a Universal Serial Bus (USB) port, a headphone jack, and other mechanical interfaces that are not explicitly shown.

The mobile device 900 comprises a power pack 958 that provides power to the other components of the mobile device 900.

The mobile device 900 may comprise other elements that, for clarity, are not illustrated in FIG. 9. Likewise, the mobile device 900 may comprise a subset of the elements illustrated in FIG. 9.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A network capability discovery method performed by a mobile device within radio communication range of an access network, the method comprising:
while not associated with the access network:
transmitting to the access network a request for information about a network capability of the access network; and
responsive to transmitting the request, receiving from the access network a response conveying information about the network capability of the access network.

2. The network capability discovery method as claimed in claim 1, wherein the request and the response comprise Access Network Query Protocol (ANQP) messages.

3. The network capability discovery method as claimed in claim 1, wherein the network capability is multimedia capability.

4. The network capability discovery method as claimed in claim 1, wherein the network capability is parental control.

5. The network capability discovery method as claimed in claim 1, wherein the network capability is content filtering.

6. A network capability discovery assistance method performed by an access point that supports an access network, the method comprising:
receiving from a mobile station a request for information about a network capability of the access network; and
responsive to receiving the request, transmitting to the mobile station a response conveying information about the network capability of the access network.

7. The network capability discovery assistance method as claimed in claim 6, wherein the request and the response comprise Access Network Query Protocol (ANQP) messages.

8. The network capability discovery assistance method as claimed in claim 6, wherein the network capability is multimedia capability.

9. The network capability discovery assistance method as claimed in claim 6, wherein the network capability is parental control.

10. The network capability discovery assistance method as claimed in claim 6, wherein the network capability is content filtering.

11. The network capability discovery assistance method as claimed in claim 6, wherein the mobile device is within radio communication range of the access point.

12. The network capability discovery assistance method as claimed in claim 6, further comprising:
responsive to receiving the request, transmitting to an advertisement server a query request; and
responsive to transmitting the query request, receiving from the advertisement server a query response,
wherein the response conveying information about the network capability of the access network is transmitted responsive to receiving the query response.

13. A mobile device comprising:
a processor; and
a wireless network interface coupled to the processor, the wireless network interface configured to:
transmit to an access network a request for information about a network capability of the access network, while the mobile device is not associated with the access network; and
responsive to transmitting the request, receive from the access network a response conveying information about the network capability of the access network, while the mobile device is not associated with the access network.

14. The mobile device as claimed in claim 13, wherein the request and the response comprise Access Network Query Protocol (ANQP) messages.

15. The mobile device as claimed in claim 13, wherein the network capability is multimedia capability.

16. The mobile device as claimed in claim 13, wherein the network capability is parental control.

17. The mobile device as claimed in claim 13, wherein the network capability is content filtering.

18. An access point comprising:
a processor; and
a wireless network interface coupled to the processor, the wireless network interface configured to:
support an access network;
receive from a mobile station a request for information about a network capability of the access network; and
responsive to receiving the request, transmit to the mobile station a response conveying information about the network capability of the access network.

19. The access point as claimed in claim 18, wherein the request and the response comprise Access Network Query Protocol (ANQP) messages.

20. The access point as claimed in claim 18, wherein the network capability is multimedia capability.

21. The access point as claimed in claim 18, wherein the network capability is parental control.

22. The access point as claimed in claim 18, wherein the network capability is content filtering.
